(19) United States
(12) Patent Application Publication
(10) Pub. No.: US 2026/0175383 A1
(43) Pub. Date: Jun. 25, 2026

(54) DRIVING TOOL

(71) Applicant: MAKITA CORPORATION, Anjo-shi (JP)

(72) Inventors: Makito TERAMOTO, Anjo-shi (JP); Kiyonobu YOSHIKANE, Anjo-shi (JP)

(73) Assignee: MAKITA CORPORATION, Anjo-shi (JP)

(21) Appl. No.: 19/395,507

(22) Filed: Nov. 20, 2025

(30) Foreign Application Priority Data
Dec. 24, 2024 (JP) 2024-227162
Jul. 22, 2025 (JP) 2025-122094

(51) Int. Cl. B25C 1/04; B25C 1/00; B25C 1/06

(52) U.S. Cl. CPC B25C 1/047; B25C 1/005; B25C 1/008; B25C 1/06

(57) ABSTRACT

A gas-pressure driving tool has a driver that strikes a fastener and has rack teeth along its driving direction. The driving tool further has a wheel, a lifter shaft, and a biasing member. The wheel has engaging portions that sequentially engage with the rack teeth as it rotates. The lifter shaft supports the wheel, allowing it to be rotatable and displaceable in a direction toward and away from the driver. The biasing member displaces the wheel relative to the lifter shaft in a direction away from the driver so that the last engaging portion, which is one of the plurality of engaging portions, disengages from the last rack tooth among the plurality of rack teeth positioned at the outermost end in the driving direction

### CROSS-REFERENCE TO RELATED APPLICATIONS

This application claims priority to Japanese patent application serial numbers 2024-227162 filed Dec. 24, 2024 and 2025-122094 filed Jul. 22, 2025, the contents of which are incorporated herein by reference in their entirety for all purposes.

### BACKGROUND

This disclosure relates to a driving tool for driving driven members such as nails or staples into a wood etc.

Conventional gas spring-powered driving tools uses the thrust of compressed gas as impact force. The gas spring-powered driving tool has a piston that moves up and down within a cylinder and a driver that is connected to the piston and moves integrally downward to strike a driven member. The piston and the driver move downward in a driving direction by gas pressure in an accumulation chamber. The driven member is struck by the driver moving downward within a driving nose and is then ejected through an ejection port. After the driven member is struck, the piston and the driver are returned from a downward movement end position to a counter-driving direction by a lift mechanism.

The lift mechanism uses an electric motor to rotate a lift wheel, which has engaging portions. These engaging portions sequentially engage with a series of rack teeth on the driver. The driver is forced upward in a counter-driving direction when the engaging portions of the lift wheel sequentially mesh with the rack teeth of the driver. This upward movement compresses gas in the accumulation chamber, increasing the pressure. When the driver reaches its end position, the last engaging portion of the lift wheel disengages from the last rack tooth. The built-up gas pressure then forces the driver back down, performing the driving operation.

When the driver is moved upward to the upward movement end position and the last engaging portion is disengaged from the last rack tooth, both components slide against each other, resulting in relatively significant wear at a tip end of the last rack tooth. A freely rotatable roller body may be provided at the final engagement section to prevent the wear of the last rack tooth. Alternatively, the wear of the last rack tooth may be reduced as the lift wheel is displaced in the driving direction relative to the drive shaft at a stage when the last engaging portion is disengaged from the last rack tooth.

It has conventionally been required to ensure that the last engaging portion disengages smoothly from the last rack tooth and that wear on the last rack tooth is more reliably reduced, without the need for additional components such as the roller body mentioned above.

### SUMMARY

According to one aspect of the present disclosure, a driving tool uses gas pressure to power a driver, which strikes a driven member. The tool has a series of rack teeth on the driver that align with the driving direction of the strike. To operate, the driving tool utilizes a wheel, a lifter shaft, and a biasing member to manage the strike sequence. The wheel has multiple engaging portions that sequentially engage with the rack teeth on the driver as the wheel rotates. The lifter shaft holds and supports the wheel, allowing it to rotate and to be displaceable in a direction toward and away from the driver. The biasing member, such as a spring, displaces the wheel relative to the lifter shaft in a direction away from the driver so that a last engaging portion of the engaging portions, disengages from a last rack tooth among the plurality of rack teeth positioned at an outermost end in the driving direction. Furthermore, the biasing member elastically deforms as the wheel is displaced in the direction away from the driver with respect to the lifter shaft when the driver strikes the driven member moving against the gas pressure.

Therefore, the last engaging portion is smoothly released from the last rack tooth, and wear of the last rack tooth is more reliably reduced. The wheel is supported so as to be rotatable about the lifter shaft and displaceable in a direction toward and away from the driver. The wheel is biased to the lifter shaft by the biasing member. The biasing member elastically deforms as the wheel is displaced in the direction away from the driver with respect to the lifter shaft when the driver strikes the driven member to move against the gas pressure. This prevents the rotation of the wheel from being locked due to a misalignment of the engaging portion with the rack tooth when, for example, a nail jam occurs.

By the configuration for avoiding a meshed and locked state at the start of lifting, the last engaging portion slides away from the last rack tooth immediately before the striking operation begins, as the wheel is biased in the direction away from the driver relative to the lifter shaft. This reduces wear of the last rack tooth.

### BRIEF DESCRIPTION OF THE DRAWINGS

FIG. 1 is a left side view of a driving tool.

FIG. 2 is a front view of the driving tool as viewed from an arrow II in FIG. 1.

FIG. 3 is a top view of the driving tool as viewed from an arrow III in FIG. 1.

FIG. 4 is a left side view of the driving tool as viewed from an arrow IV in FIG. 3. This figure shows the driving tool with a left half housing removed.

FIG. 5 is a right side view of the driving tool in FIG. 3 as viewed from an arrow V in FIG. 3. This figure shows the driving tool with a right half housing removed.

FIG. 6 is a vertical sectional view of a lift mechanism taken along line VI-VI in FIG. 1.

FIG. 7 is a top view of a nose and the lift mechanism as viewed from an arrow VII in FIG. 5.

FIG. 8 is a vertical sectional view of a lifter shaft, a primary gear, and a wheel taken along line VIII-VIII in FIG. 7.

FIG. 9 is a cross sectional view of the lifter shaft and the wheel taken along line IX-IX in FIG. 7.

FIG. 10 is a vertical sectional view taken along line X-X in FIG. 3, illustrating a movement of a tool main body. This figure shows the driver in a standby position.

FIG. 11 is a vertical sectional view illustrating the movement of the tool main body. This figure shows the driver moved to a retraction end position.

FIG. 12 is an enlarged view of a last engaging portion engaged with a last rack tooth.

FIG. 13 is a vertical sectional view illustrating the movement of the tool main body. This figure shows a state in which the wheel is returned to a reference position and the last engaging portion of the wheel is disengaged from the last rack tooth of the driver.

FIG. 14 is a vertical sectional view illustrating the movement of the tool main body. This figure shows a state in which a first engaging portion of the wheel is engaged with a first rack tooth of the driver and a returning movement of the driver to the standby position has started.

FIG. 15 is a vertical sectional view illustrating the movement of the tool main body. This figure shows a state in which a second engaging portion of the wheel is engaged with a second rack tooth of the driver and the returning movement of the driver to the standby position is in progress.

FIG. 16 is a vertical sectional view illustrating the movement of the tool main body. This figure shows a state in which the second engaging portion is engaged with the second rack tooth and the wheel is displaced in a retracting direction with respect to the lifter shaft.

FIG. 17 is a vertical sectional view illustrating the movement of the tool main body. This figure shows a state in which the first engaging portion of the wheel is engaged with the second rack tool of the driver stopped before a leading end and the wheel is displaced in a direction away from the driver (toward a retracted position).

FIG. 18 is a perspective view of the wheel alone.

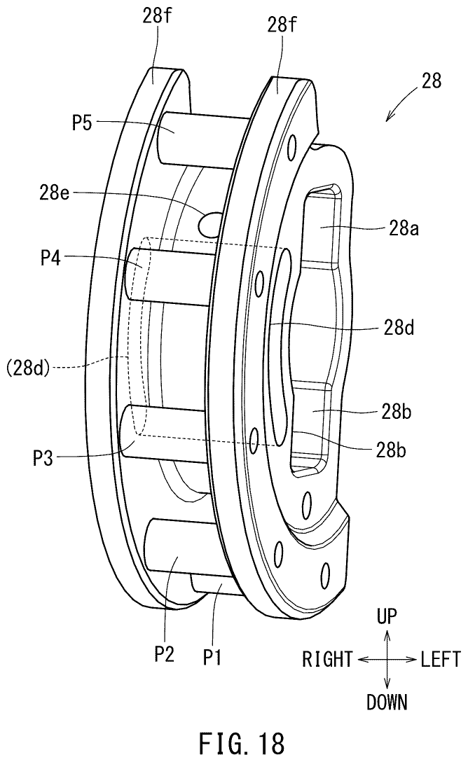

FIG. 19 is a partially enlarged view of FIG. 11. This figure illustrates the engaged state of the last engaging portion with the last rack tooth when the driver has moved to the retraction end position. This figure shows a state in which the wheel has been displaced toward the retracted position.

FIG. 20 is a cross-sectional view of the lift mechanism according to a second example. This figure shows the engaged state of the last engaging portion with the last rack tooth when the driver has moved to the retraction end position. This figure shows a state in which the wheel is displaced toward the retracted position.

FIG. 21 is a cross-sectional view of the lift mechanism according to the second example. This figure illustrates a state in which the last engaging portion is disengaged from the last rack tooth when the driver has moved to the retraction end position. This figure shows a state in which the wheel is returned to the reference position.

### DETAILED DESCRIPTION

One embodiment of the present disclosure includes a guide surface of a width-across-flats portion provided on a lifter shaft. The wheel slidably moves in the radial direction with respect to the lifter shaft along the guide surface. Therefore, the wheel slidably moves in the radial direction with respect to the lifter shaft via the guide surface of the width-across-flats portion.

In one embodiment of the present disclosure, a biasing member is disposed between guide surfaces of the width-across-flats portion. Thus, the biasing member is compactly disposed in the lifter shaft.

In one embodiment of the present disclosure, the last engaging portion is located forward of the rotation direction of the wheel with respect to a virtual plane including the guide surfaces of the width-across-flats portion. Therefore, the wheel is easily slidable in the radial direction immediately before the last engaging portion disengages from the last rack tooth.

In one embodiment of the present disclosure, a plurality of engaging portions include a first engaging portion that first engages with a plurality of rack teeth when the driver is moved against gas pressure. At least a part of the first engaging portion is located between two virtual planes including guide surfaces of the width-across-flats portion. Therefore, the wheel is easily slidable in the radial direction at the stage when the first engaging portion is engaged with the rack teeth of the driver.

In one embodiment of the present disclosure, the last rack tooth has engaging surfaces that sequentially contact the engaging portion and extend in different extending directions. After the last engaging portion moves from an initial engaging surface to a different engaging surface, the wheel is displaced in a direction away from the driver due to the biasing force of the biasing member. Therefore, when the last engaging portion moves from the initial engaging surface to the different engaging surface that has a different extending direction, the external force applied to the last engaging portion from the last rack tooth changes. As a result, immediately before the driving operation, the wheel slides in the direction away from the driver due to the biasing force of the biasing member, thereby reducing wear of the last rack tooth.

In one embodiment of the present disclosure, a plurality of engaging surfaces of the last rack tooth includes a flat surface and a circular arc surface. After the last engaging portion has moved from the flat surface to the circular arc surface, the wheel is displaced due to the biasing force of the biasing member. Therefore, as the direction of the external force applied from the last rack tooth changes when the last engaging portion moves from the flat surface to the circular arc surface, the wheel smoothly moves in the direction away from the driver due to the biasing force of the biasing member.

In one embodiment of the present disclosure, the wheel has a grease sump between the plurality of engaging portions and the lifter shaft. Grease is fed from the grease sump to at least one of the plurality of engaging portions. Therefore, grease flows due to centrifugal force generated by rotation of the wheel and is fed to at least one of the plurality of engaging portions.

In one embodiment of the present disclosure, the grease sump extends in a circular arc shape. A grease filling hole extends from a rear end of the grease sump in the rotation direction of the wheel toward the last engaging portion. Therefore, grease is efficiently fed to the last engaging portion through the grease filling hole.

In one embodiment of the present disclosure, the last rack tooth includes a flat surface and a circular arc surface with different extending directions. When the last engaging portion moves from the flat surface to the circular arc surface and the last engaging portion leaves the circular arc surface, the guide surface of the lifter shaft is located substantially parallel to the flat surface of the last rack tooth. Therefore, the wheel moves smoothly in the direction away from the driver due to the biasing force, thereby reducing wear of the last rack tooth.

In one embodiment of the present disclosure, the lifter shaft has two guide surfaces that extend in a direction orthogonal to the axis of rotation of the lifter shaft and slidably hold the wheel in the extending direction. The lifter shaft has force points where each of the two guide surfaces contacts the wheel when the lifter shaft transmits the rotational power to the wheel. The lifter shaft is located on the opposite side of the engaging portion where the center of the two force points is provided to the wheel with respect to the axis of rotation. Therefore, even if the last engaging portion is disposed toward the rear in the rotation direction, the wheel can be displaced in the direction away from the driver by the biasing force of the biasing member when the last engaging portion moves away from the last rack tooth.

In this way, when the wheel is configured to slide toward the retracted position both at the time when the first engaging portion engages with the first rack tooth at the start of lifting and at the time when the last engaging portion disengages from the last rack tooth at the end of lifting, the wheel diameter can be made smaller while ensuring the lifting amount of the driver. By reducing the wheel diameter smaller, the lifter shaft and the wheel can be disposed closer to the driver side. This makes it possible to downsize the driving tool by reducing the size of the inner housing that accommodates the wheel.

In one embodiment of the present disclosure, among the two guide surfaces, the one guide surface closer to the last engaging portion is located nearer to the center line that passes through the axis of rotation and extends in the extending direction of the guide surface than the other guide surface. Therefore, it is also possible to bring the wheel closer to the driver by placing the last engaging portion further rearward in the rotation direction.

In one embodiment of the present disclosure, the center line of the biasing member extending in the biasing direction through the center of the biasing member is located on the opposite side of the engaging portion with respect to the axis of rotation of the lifter shaft. Therefore, the biasing member is offset to the rear side in the rotation direction with respect to the axis of rotation of the lifter shaft. As a result, as the biasing member offsets to the same side in response to the displacement of the force point of the last engaging portion among the two force points to the side away from the last engaging portion, the wheel can displace smoothly in the radial direction with respect to the lifter shaft.

In one embodiment of the present disclosure, the biasing member is a coil spring. The biasing member has two guide surfaces, one located inside a width area of the coil spring, the biasing member, and the other located outside the width area. Therefore, the biasing member is compactly arranged over an area between the two guide surfaces.

In one embodiment of the present disclosure, an acting part having a guide receiving surface slidably contacting the guide surface located within the width area of the coil spring is provided on the wheel. Thus, a force point on the last engaging portion side is set between the guide surface and the guide receiving surface.

### EMBODIMENTS

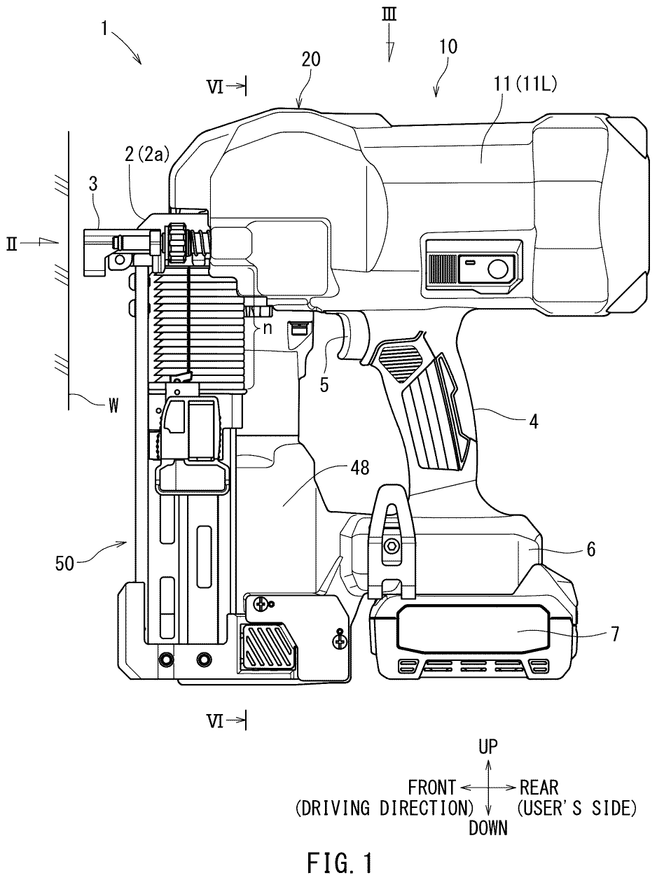

Next, an example of the present invention will be described. In this embodiment, as an example of a driving tool 1, a gas spring-powered driving tool 1 is shown, which uses gas pressure in an accumulation chamber as a thrust for driving the driven member n. In the following description, an example will be described in which a user holds the driving tool 1 in a forward-facing posture. Accordingly, a driving direction of the driven member n will be determined as a forward direction, and a counter-driving direction will be determined as a rearward direction. The user of the driving tool 1 is located at rear side (substantially right side of the driving tool 1 in FIG. 1). Upper, lower, left, and right directions are determined with reference to the user.

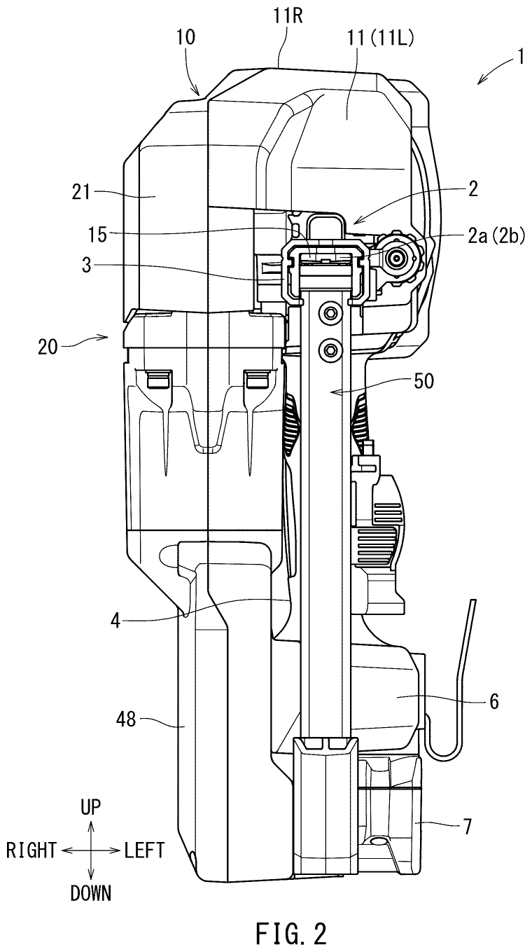

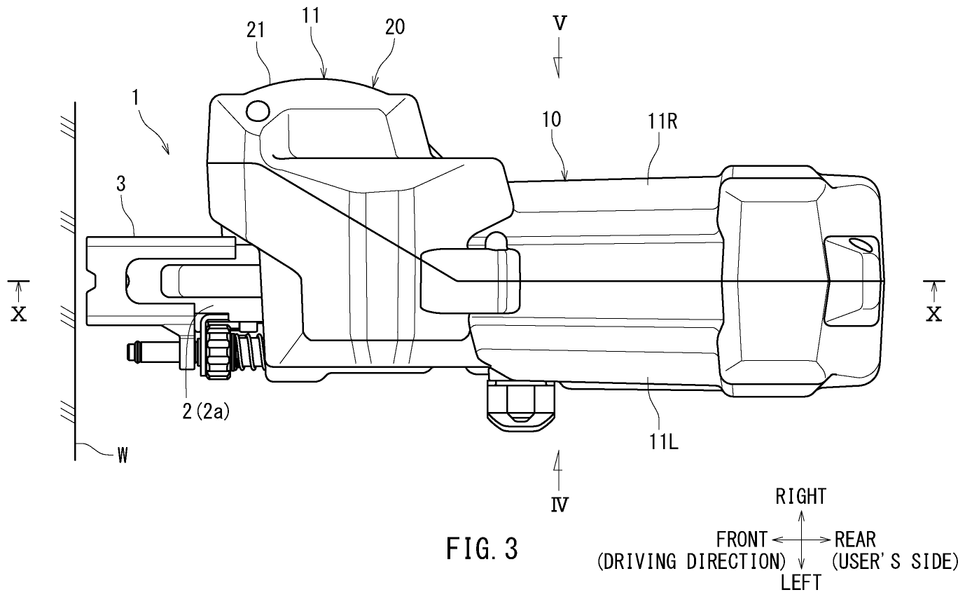

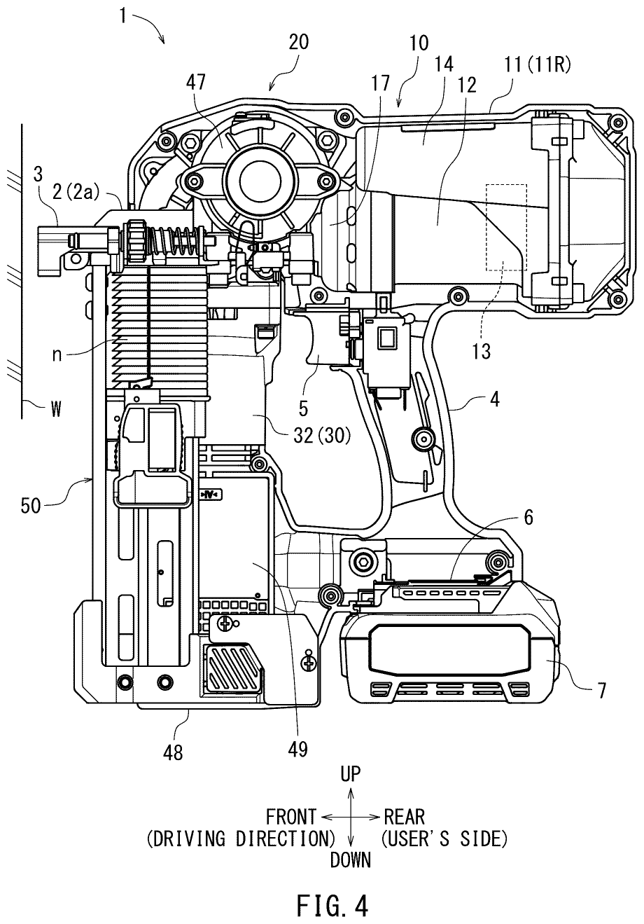

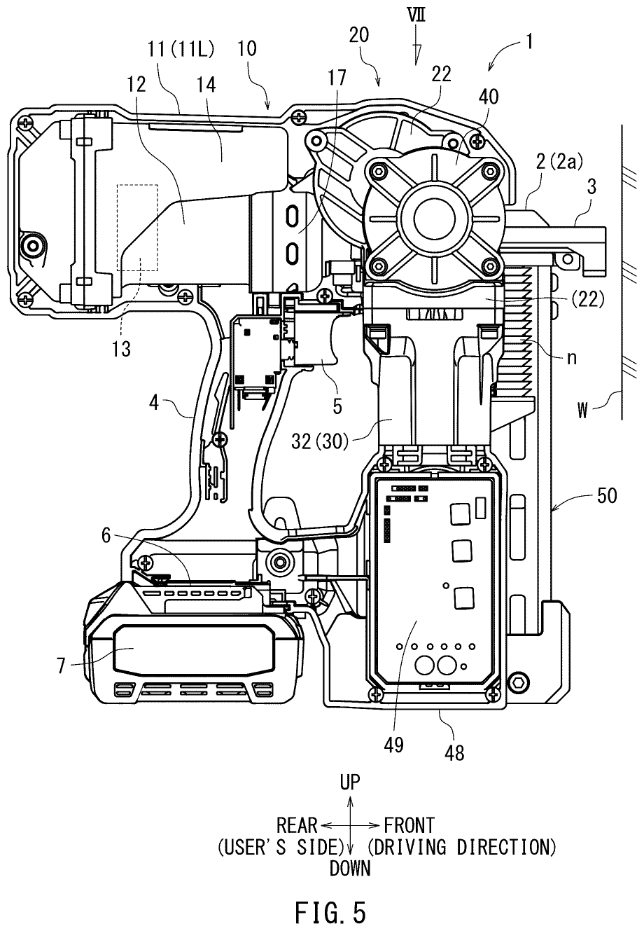

As shown in FIGS. 1 to 6, the driving tool 1 has a tool main body 10. The tool main body 10 has a cylinder 12 accommodated in a substantially cylindrical main body housing 11. The main body housing 11 has a split structure divided into left and right halves. The main body housing 11 is formed by joining the left half housing 11L on the left side and the right half housing 11R on the right side.

A piston 13 reciprocally moves inside the cylinder 12 in a front-rear direction. The rear part of the cylinder 12 behind the piston 13 is connected to an accumulation chamber 14, which holds a sealed, compressed gas like air. The pressure from this gas in the accumulation chamber 14 acts as a thrust, pushing the piston 13 forward in the driving direction.

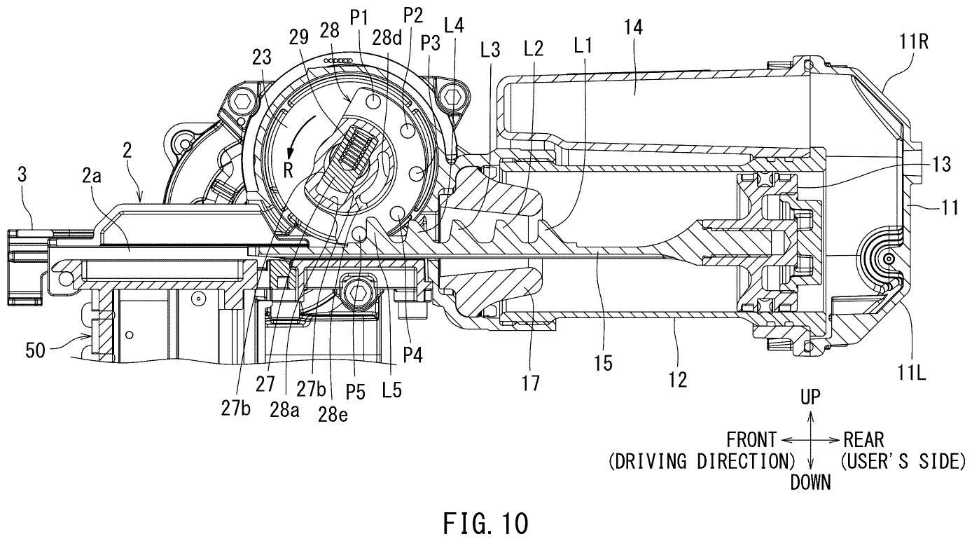

As shown in FIG. 10, a front part of the cylinder 12 is communicated to a driving passage 2a of a driving nose portion 2 provided at a front part of the tool main body 10. A magazine 50 loaded with driven members n is coupled to the driving nose portion 2. The driven members n are fed one by one from the magazine 50 into the driving passage 2a. The driven members n are fed in a posture extending in a front-rear direction. A contact arm 3 capable of relative movement in the front-rear direction is provided at a front part of the driving nose portion 2. The contact arm 3 retracts relative to the driving nose portion 2 when coming into contact with a workpiece W.

A driver 15 that is long in the front-rear direction is coupled to a front side of the piston 13. A front part of the driver 15 enters the driving passage 2a. The driver 15 advances in the driving passage 2a by the gas pressure in the accumulation chamber 14 acting on a rear side of the piston 13. The front end of the driver 15 strikes a single driven member n fed into the driving passage 2a. The struck driven member n is ejected from an ejection port 2b of the driving nose portion 2. The ejected driven member n is driven into a workpiece W.

A leading end damper 17 is disposed at a front part of the cylinder 12 to absorb impact at the leading end of the piston 13. The driver 15 enters the inner circumference of the leading end damper 17. When the driver 15 reaches the leading end and the driving operation is initiated, the piston 13 collides with the leading end damper 17.

Once the piston 13 hits the leading end damper 17 and stops at the leading end position, a lift mechanism 20 returns both the piston 13 and the driver 15 to a rear standby position. FIG. 10 shows the state when the piston 13 and the driver 15 return to the standby position. When the driver 15 is further retracted to the retraction end position by rotation of a wheel 28 in the standby position, the last engaging portion P5 of the wheel 28 disengages from the last rack tooth L5 of the driver 15. Upon disengagement from the last rack tooth L5, the piston 13 moves downward due to the gas pressure acting on the rear side. Thus, the driver 15 moves forward in the driving direction to initiate driving operation.

The driver 15 has five rack teeth L arranged on its upper surface. Each rack tooth L is provided at a constant interval from each other in a longitudinal direction (front-rear direction) of the driver 15. Each rack tooth L is provided in a state protruding upward. Hereinafter, the five rack teeth L are referred to as a first rack tooth L1, a second rack tooth L2, a third rack tooth L3, a fourth rack tooth L4, and a last rack tooth L5, in order from the rear. The last rack tooth L5 is located at the outermost end in the driving direction. During operation, the driver 15 is pulled back from its leading end position to the rear standby position as the engaging portion P of the lift mechanism 20 (described later) sequentially mesh with each of the five rack teeth L.

As shown in FIG. 1, a grip 4 for the user to hold is provided at approximately the middle of the tool main body 10 in the front-rear direction. A trigger 5 for the user to pull with his fingertips to operate is provided on the upper front surface of the grip 4. The contact arm 3 is pressed against the workpiece W and moved relatively rearward of the driving nose portion 2, thereby enabling the pulling operation of the trigger 5. A battery attachment portion 6 is provided at a lower part of the grip 4. A battery pack 7 can be removably attached to a lower surface of the battery attachment portion 6. The battery pack 7 can be removed from the battery attachment portion 6 by sliding it rearward relative to the battery attachment portion 6. The removed battery pack 7 can be repeatedly used by charging it with a separately provided charger. The electric power of the battery pack 7 is fed to the lift mechanism 20.

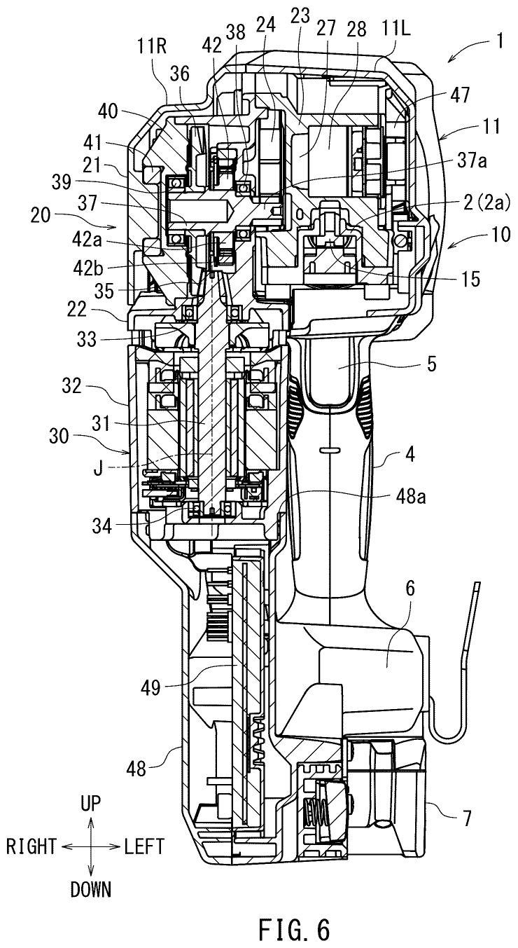

A lower housing 48 is connected to a front part of the battery attachment portion 6. The lower housing 48 is provided so as to protrude forward. A rectangular flat-plate-shaped controller 49 is installed inside the lower housing 48. As shown in FIG. 6, the controller 49 is supported in an upright position. The controller 49 mainly controls the operation of the electric motor 30. An upper part of the lower housing 48 is open. A lower part of the electric motor 30 is held in an upper opening 48a of the lower housing 48.

The lift mechanism 20 is disposed across an area extending to a right side and upward of the driving nose portion 2. The lift mechanism 20 has a function of returning the piston 13 and the driver 15 integrally to a rear standby position after striking. As the piston 13 is returned rearward by the lift mechanism 20, gas pressure in the accumulation chamber 14 is increased.

As shown in FIG. 6, the lift mechanism 20 is located inside a lift housing 21, which is on a right side of the right half housing 11R. The lift housing 21 opens at the bottom, and the opening is covered by a right lift base 22. An electric motor 30 is mounted on the right lift base 22. An upper opening 48a of the lower housing 48 is located opposite the lower opening of the lift housing 21. The electric motor 30 is held so as to be interposed between the opening of the lift housing 21 and the upper opening 48a of the lower housing 48.

The electric motor 30 is supported in an orientation with an axis (motor axis J) of an output shaft 31 aligned in the up/down direction. Therefore, the motor axis J is orthogonal to the driving direction (the direction orthogonal to the plane of the sheet in FIG. 6). The electric motor 30 is activated by pulling the trigger 5, using the electric power of the battery pack 7 as a power source. The magazine 50 is located along the left side of the electric motor 30.

As shown in FIG. 6, the output shaft 31 of the electric motor 30 is rotatably supported on the motor housing 32 via bearings 33 and 34. A driving bevel gear 35 is provided at an upper portion of the output shaft 31. The driving bevel gear 35 is meshed with a large-diameter driven bevel gear 36. The driven bevel gear 36 is supported by an intermediate shaft 37. The intermediate shaft 37 is rotatably supported around its axis via bearings 38 and 39. The axis of rotation of the intermediate shaft 37 is orthogonal to the motor axis J and the driving direction.

The left bearing 38 is attached to the right lift base 22. The right bearing 39 is attached to a circular plate-shaped cover 40 attached so as to cover the opening of the right lift base 22. A ring-shaped elastic member 41 is interposed between the cover 40 and the lift housing 21. The vibration of the lift mechanism 20 is absorbed by the elastic member 41.

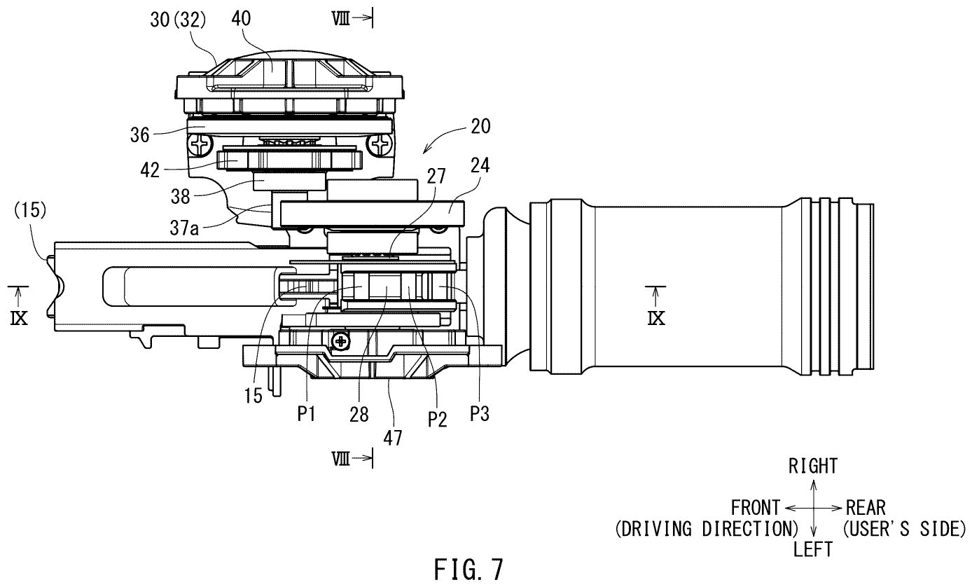

As shown in FIGS. 6 and 7, a one-way clutch 42 is interposed between the intermediate shaft 37 and the lift base 22. The one-way clutch 42 has a plurality of roller bodies 42b interposed between the lift base 22 and a clutch plate 42a coupled to the intermediate shaft 37. Although not shown in the figure, each roller body 42b is located in a recess provided between the clutch plate 42a and the lift base 22. Each recess gradually changes in depth in the direction of rotation. When the intermediate shaft 37 rotates in in the direction that causes the driver 15 to return to the standby position (clockwise rotation as viewed from the left), each roller body 42b of the one-way clutch 42 is displaced to the deep part of the recess. Therefore, the rotation of the intermediate shaft 37 is not locked by the one-way clutch 42, and the wheel 28 and the lifter shaft 27 rotate in the direction (counterclockwise as viewed from the left) that causes the driver 15 to retract, thereby returning the driver 15 rearward.

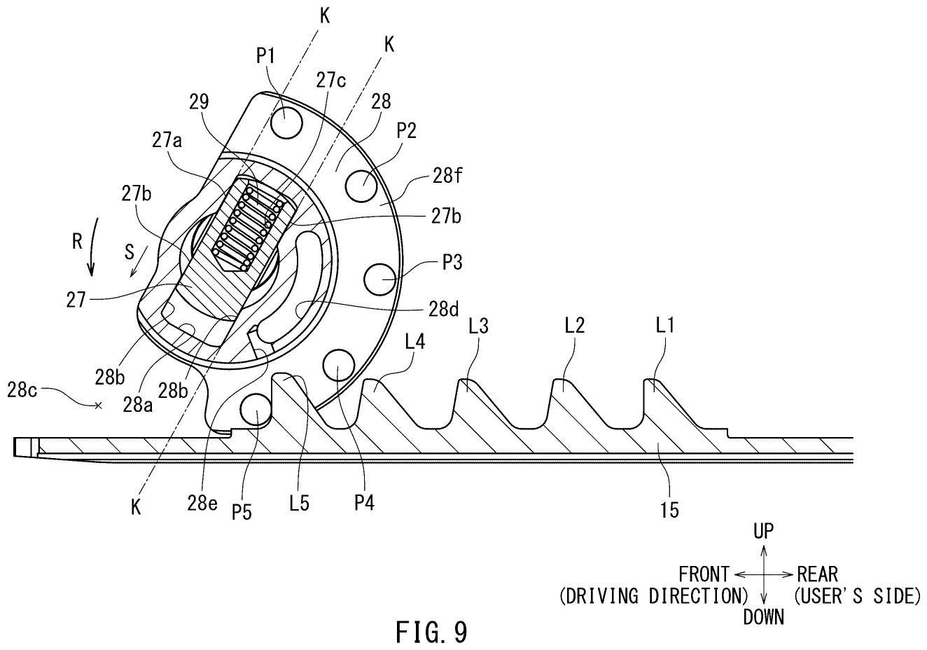

When an external force that causes rotation in the opposite direction (rotation in the direction opposite to arrow R in FIG. 9) is applied to the wheel 28 and the lifter shaft 27, for example, by the rack teeth L of the driver 15 during forward movement, each roller body 42b of the one-way clutch 42 is displaced to the shallow part of the recess. As a result, the rotation of the clutch plate 42a relative to the lift base 22 is locked, thereby locking the rotation of the intermediate shaft 37. This prevents excessive external torque from being applied to the electric motor 30, thereby increasing the durability of the electric motor 30.

A left part of the intermediate shaft 37 protrudes to left from the right lift base 22. A left lift base 23 is coupled to the left side of the right lift base 22. The right lift base 22 is located in the right half housing 11R of the main body housing 11, and the left lift base 23 is located in the left half housing 11L of the main body housing 11.

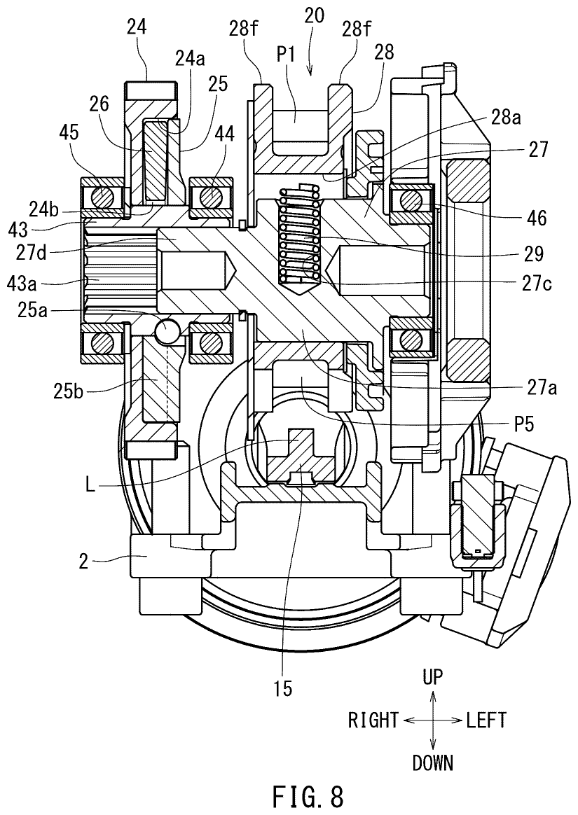

A secondary gear 37a is provided on the left side of the intermediate shaft 37. The secondary gear 37a meshes with a primary gear 24. A spur gear is used for the secondary gear 37a and the primary gear 24. As shown in FIG. 8, the primary gear 24 is rotatably supported relative to a connecting sleeve 43. The connecting sleeve 43 is rotatably supported on the left lift base 23 via two bearings 44 and 45. A drive ring 25 is supported on the connecting sleeve 43. The drive ring 25 is housed in a recess 24a in the thickness direction of the primary gear 24. The drive ring 25 is integrally rotatable with the connecting sleeve 43 via a plurality of steel balls 25a.

A plurality of ribs 24b projecting in the thickness direction are provided in the recess 24a of the primary gear 24. A plurality of ribs 25b projecting in the thickness direction are provided on a right side of the drive ring 25. A cushion member 26 is interposed between each rib 24b of the primary gear 24 and each rib 25b of the drive ring 25. The shocks in the rotation direction between the primary gear 24 and the drive ring 25 are absorbed by a plurality of cushion bodies 26 arranged around the axis of rotation of the primary gear 24.

A spline hole 43a is formed on an inner circumference of the connecting sleeve 43. A spline shaft portion 27d of the lifter shaft 27 is inserted into the spline hole 43a. The lifter shaft 27 and the connecting sleeve 43 are integrally rotatable via spline fitting between the spline shaft portion 27d and the spline hole 43a. A left part of the lifter shaft 27 is rotatably supported to a circular plate-shaped cover 47 via a bearing 46. As shown in FIG. 6, the cover 47 is held on the inner surface of the left half housing 11L on the left side. The axis of rotation of the lifter shaft 27 is orthogonal to both the motor axis J and the driving direction.

As shown in FIGS. 7, 8, and 9, a wheel 28 is supported on the lifter shaft 27. The wheel 28 has two flange portions 28f that covers approximately half of its circumference. The two flange portions 28f are arranged facing each other on the left and right sides. Five identical engaging portions P (first engaging portion P1, second engaging portion P2, third engaging portion P3, fourth engaging portion P4, and last engaging portion P5) are positioned at substantially equal intervals around the peripheral edge of the wheel 28, extending between the two flanges. The five identical engaging portions P are made of metal shafts with the same diameter and length. As the wheel 28 rotates, the five engaging portions P sequentially grip the five rack teeth L on the driver 15, pulling the driver 15 back from its leading end position to the rear standby position.

As shown in FIG. 9, a width-across-flats portion 27a is formed on the lifter shaft 27. Two guide surfaces 27b parallel to each other are provided on the width-across-flats portion 27a. A single retaining hole 27c is provided between the two guide surfaces 27b. The retaining hole 27c is formed with the radial direction of the lifter shaft 27 as a depth direction. A single biasing member 29 is retained in the retaining hole 27c. Thus, the biasing member 29 is disposed between the two guide surfaces 27b of the width-across-flats portion 27a. In this embodiment, a compression spring (coil spring) is used as the biasing member 29.

The wheel 28 is supported on the width-across-flats portion 27a of the lifter shaft 27. An elongated support hole 28a is provided at the rotation center of the wheel 28. Two support surfaces 28b parallel to each other are provided in the support hole 28a. By inserting the width-across-flats portion 27a into the support hole 28a, the wheel 28 is supported so as to be integrally rotatable with the lifter shaft 27. The guide surfaces 27b of the lifter shaft 27 slidably contact with the two support surfaces 28b of the support holes 28a, respectively. As a result, the wheel 28 is supported so as to be slidable relative to the lifter shaft 27 within a certain range in the radial direction (sliding direction S).

The sliding direction S of the wheel 28 is aligned with the direction in which the first engaging portion P1 moves toward and away from the lifter shaft 27. The biasing member 29 pushes the wheel 28 in the direction that the first engaging portion P1 separates from the lifter shaft 27. FIG. 8 shows a state immediately after a strike, in which the wheel 28 has slid in the direction (upward in FIG. 8) to separate the first engaging portion P1 from the lifter shaft 27 under the biasing force of the biasing member 29. FIG. 9 shows a state immediately before the strike, in which the wheel 28 has slid in the direction (downward in FIG. 9) that the first engaging portion P1 approaches the lifter shaft 27 against the biasing force of the biasing member 29 due to the thrust in the driving direction of the driver 15 applied through the last engaging portion P5. Hereinafter, with regard to the relative positions of the lifter shaft 27 and the wheel 28, the position at which the wheel 28 has slid in a direction to separate the first engaging portion P1 from the lifter shaft 27 due to the biasing force of the biasing member 29 (the position at which the compression spring 29 is extended) will be referred to as the “reference position” as shown in FIG. 8. As shown in FIG. 9, a position at which the first engaging portion P1 has slid in the direction in which the first engaging portion P1 approaches the lifter shaft 27 against the biasing member 29 (the position at which the compression spring 29 is compressed) will be referred to as the “retracted position.”

The last engaging portion P5 is located forward (to the right in FIG. 9) of the rotation direction R of the wheel 28 with respect to a virtual plane K including the guide surface 27b of the width-across-flats portion 27a.

When the driver 15 is moved rearward against the gas pressure, at least a part of the first engaging portion P1, which first engages with the plurality of rack teeth L, is located between two virtual planes K including the guide surface 27b of the width-across-flats portion 27a. As shown in FIG. 9, almost the entire first engaging portion P1 is located between the two virtual planes K.

When the electric motor 30 is started, the lifter shaft 27 of the lift mechanism 20 and the wheel 28 rotate integrally in the direction indicated by the arrow R shown in FIG. 9. As the wheel 28 rotates in the direction of the arrow R, the driver 15 is returned rearward from the leading end position.

The five engaging portions P of the wheel 28 are located in an area narrower than half the circumference of peripheral edge of the wheel 28. With respect to the rotation direction R of the wheel 28, the second engaging portion P2 is provided adjacent to the counter-rotation direction side of the first engaging portion P1. The third engaging portion P3, the fourth engaging portion P4, and the last engaging portion P5 are successively arranged adjacent to the counter-rotation direction side. The remaining area of the peripheral edge of the wheel 28 (the area between the first engaging portion P1 and the last engaging portion P5) is defined as a relief section 28c.

The relief section 28c faces the driver 15, thereby preventing interference between the engaging portion P of the wheel 28 and the rack tooth L of the driver 15. This allows the driver 15 to move smoothly in the driving direction (driving operation). When the rack tooth L of the driver 15 is disengaged from the engaging portion P of the wheel 28, the wheel 28 is positioned at the reference position due to the biasing force of the biasing member 29.

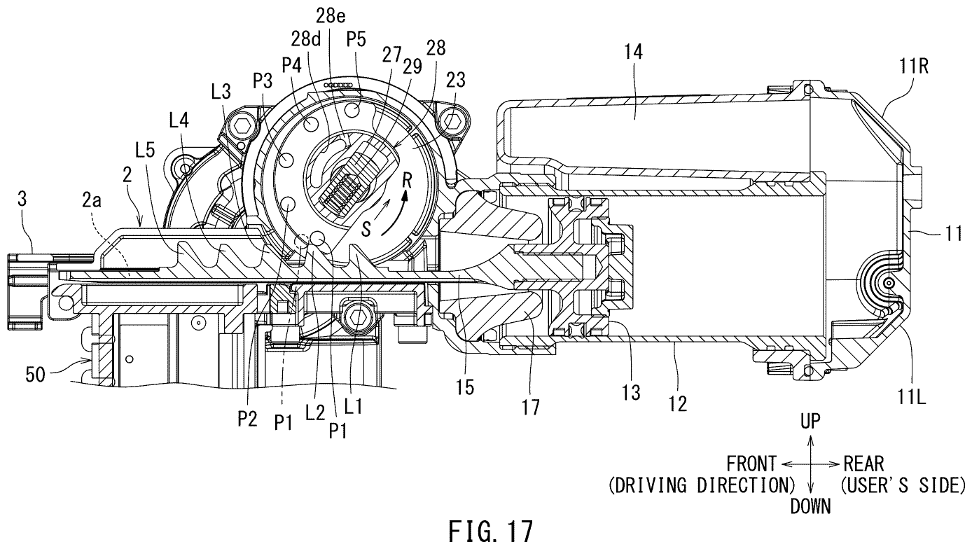

As shown in FIGS. 9 and 17, a circular arc groove-shaped grease sump 28d is formed in the wheel 28. The grease sump 28d is provided between the support hole 28a (lifter shaft 27) and the engaging portion P. Grease is filled in advance into the grease sump 28d. During operation of the driving tool 1, grease flows from the grease sump 28d toward the engaging portion P due to centrifugal force generated by the rotation of the wheel 28.

The grease sump 28d is provided to pass through the left and right flange portions 28f. The grease sump 28d feeds grease primarily out from both ends of grease sump 28d to ends of each engaging portion P. A grease filling hole 28e is at the retraction end of the grease sump 28d in the rotation direction R of the wheel, leading toward the last engaging portion P5. The grease filling hole 28e, which is positioned between the left and right flange portions 28f, allows grease to flow from the grease sump 28d directly to the last engaging portion P5 through the grease filling hole 28e. This ensures that the last engaging portion P5 receives sufficient lubrication, significantly improving the wear resistance of the last engaging portion P5.

FIG. 10 shows the driver 15 stopped at the standby position. In the standby position, the last engaging portion P5 of the wheel 28 is engaged with a lower surface of the last rack tooth L5 of the driver 15. In the standby position, thrust in the driving direction of the driver 15 is applied to the wheel 28 through the last engaging portion P5. In the standby position, the thrust of the driver 15 is applied to the last engaging portion P5 as an external force directed forward or downward in the diagonally forward direction. In the standby position, the slidable direction of the wheel 28 relative to the lifter shaft 27 (the extending direction of the guide surface 27) is oriented downward in a diagonally forward direction. For this reason, the wheel 28 slides to a retracted position in which it approaches the driver 15 against the biasing force of the biasing member 29 relative to the lifter shaft 27.

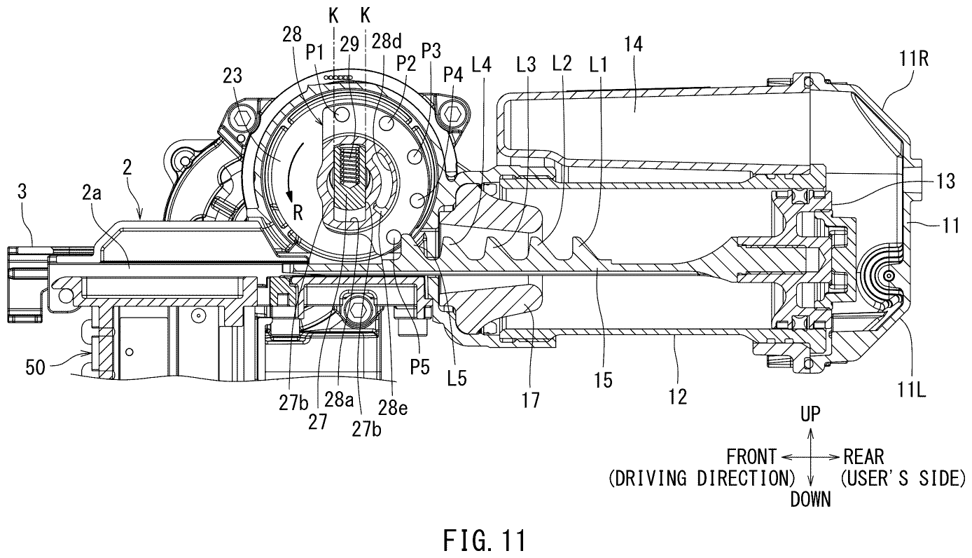

When the electric motor 30 is started from the standby position shown in FIG. 10, the wheel 28 rotates in the direction of the arrow R. As a result, as shown in FIG. 11, the driver 15 and the piston 13 move to the retraction end position. The rotation of the wheel 28 displaces the last engaging portion P5 rearwardly and obliquely upward (in the direction away from the driver 15). Therefore, in the process of moving from the standby position to the retraction end position, the last engaging portion P5 comes slidably in contact with the front surface (engaging surface 15a) of the last rack tooth L5.

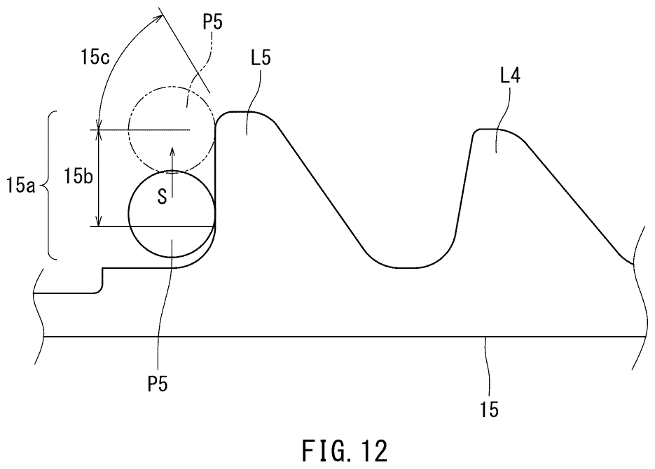

As shown in FIG. 12, the engaging surface 15a of the last rack tooth L5 has a flat surface 15b and a circular arc-shaped circular arc surface 15c. The flat surface 15b extends in a direction substantially orthogonal to the driving direction. Therefore, as the driver 15 moves from the standby position to the retraction end, the last engaging portion P5 moves from a slidable contact state with the flat surface 15b (position indicated by a solid line in FIG. 12) to a slidable contact state with the circular arc surface 15c (position indicated by a phantom line in FIG. 12).

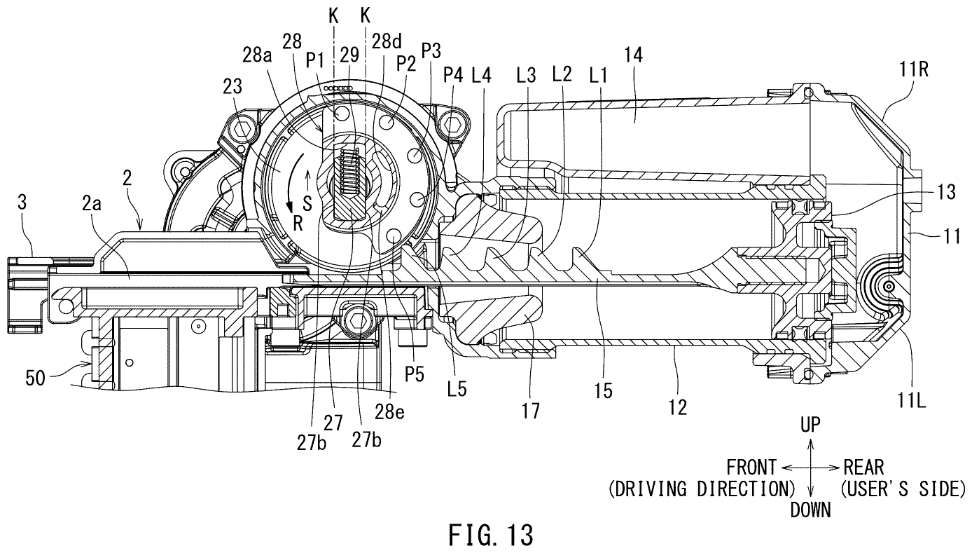

As shown in FIGS. 11 and 12, at a stage where the last engaging portion P5 moves from the flat surface 15b to the circular arc surface 15c, the guide surface 27b of the lifter shaft 27 is located substantially parallel to the flat surface 15b of the last rack tooth L5. Therefore, as shown in FIG. 13, when the driver 15 reaches the retraction end and the last engaging portion P5 moves away from the circular arc surface 15c via the flat surface 15b, the thrust of the driver 15 ceases, causing the wheel 28 to displace instantaneously in the direction away from the driver 15 with respect to the lifter shaft 27 (reference position) due to the biasing force of the biasing member 29. As a result, the last engaging portion P5 immediately moves away from the last rack tooth L5. Because the last engaging portion P5 immediately moves away from the last rack tooth L5, the wear of the last rack tooth L5 is reduced. When the last engaging portion P5 moves away from the last rack tooth L5, the driver 15 moves forward due to the thrust acting on the rear surface of the piston 13, causing the driving operation. The wheel 28 continues to rotate in the direction indicated by the arrow R.

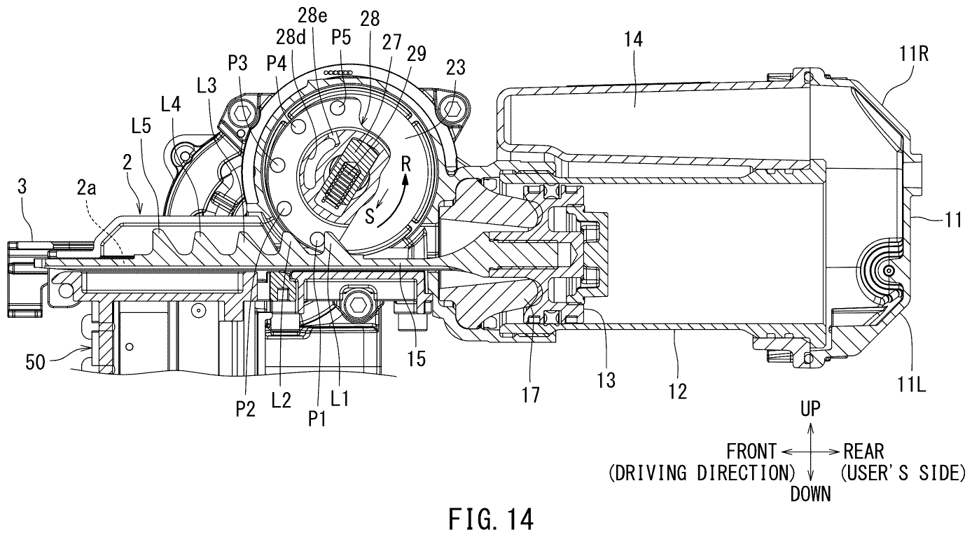

As shown in FIG. 14, once the driver 15 reaches its forward-most position and normal strike has occurred, the first engaging portion P1 of the wheel 28 engages with the front surface of the first rack tooth L1. This action starts the return movement of the driver 15 to its standby position. After the last engaging portion P5 disengages from the last rack tooth L5, the wheel 28 is held in a reference position relative to the lifter shaft 27 by the biasing member 29. The wheel remains in this reference position during the driver's forward-moving strike until the first engaging portion P1 re-engages with the rack tooth L (during the driving operation of the driver 15).

For example, as shown in FIG. 17, an abnormal driving operation may occur. For example, there may be cases of nail jamming or insufficient driving force. In this case, the driver 15 may stop immediately before the leading end, specifically, the piston 13 may stop at the rear position of the damper. At this time, the first engaging portion P1 is retracted in the direction away from the rack tooth L, thereby avoiding interference (meshed and locked) state between the first engaging portion P1 and the rack tooth L. For example, as a result of the driver 15 stopping immediately in front of the leading end due to a nail jam, or the like, the first engaging portion P1 shown by the phantom line in the figure interferes with a head of the second rack tooth L2 instead of the first rack tooth L1. At this time, the wheel 28 is displaced to the retracted position against the biasing member 29 as shown by the solid line in the figure due to the gas pressure in the accumulation chamber 14 applied to the wheel 28 through the first engaging portion P1. As a result, the first engaging portion P1 is displaced to the position shown by the solid line in the figure, thereby avoiding interference of the first engaging portion P1 with the second rack tooth L2. By avoiding interference with the second rack tooth L2, the first engaging portion P1 is properly engaged with a lower side of the first rack tooth L1. Therefore, after the meshed and locked state is avoided, the driver 15 is returned upward in a normal engagement state. This facilitates the removal of the jammed nail.

After normal driving operation is performed, the first engaging portion P1 of the wheel 28 engages with the front surface of the first rack tooth L1, and the returning movement of the driver 15 begins to the standby position. The wheel 28 rotates approximately one-half turn to move the driver 15 upward from the leading end position to the standby position and then to the upward movement end position. During this time, the gas pressure in the accumulation chamber 14 acts on each engaging portion P of the wheel 28 through each rack tooth L of the driver 15. Of the total thrust of the gas pressure, the component in the sliding direction between the support surface 28b of the support hole 28a and the guide surface 27b of the lifter shaft 27 acts in the direction to move the wheel 28 closer to the driver 15. Therefore, as shown in FIG. 14, at the time when the returning movement of the driver 15 begins, the wheel 28 is located at the reference position due to the thrust of the gas pressure and the biasing force of the biasing member 29.

During one rotation of the wheel 28 (one driving operation), the wheel 28 reciprocates once between the reference position and the retracted position due to the gas pressure acting on each engaging portion P. In a rotation range from the retraction end position shown in FIG. 13 to the position shown in FIG. 14, the thrust of the gas pressure does not act on the wheel 28. The retraction end position shown in FIG. 13 is the position at which the last engaging portion P5 moves away from the last rack tooth L5. At the position shown in FIG. 14, the first engaging portion P1 meshes with the first rack tooth L1. At this time, the wheel 28 is held at the reference position by the biasing force of the biasing member 29.

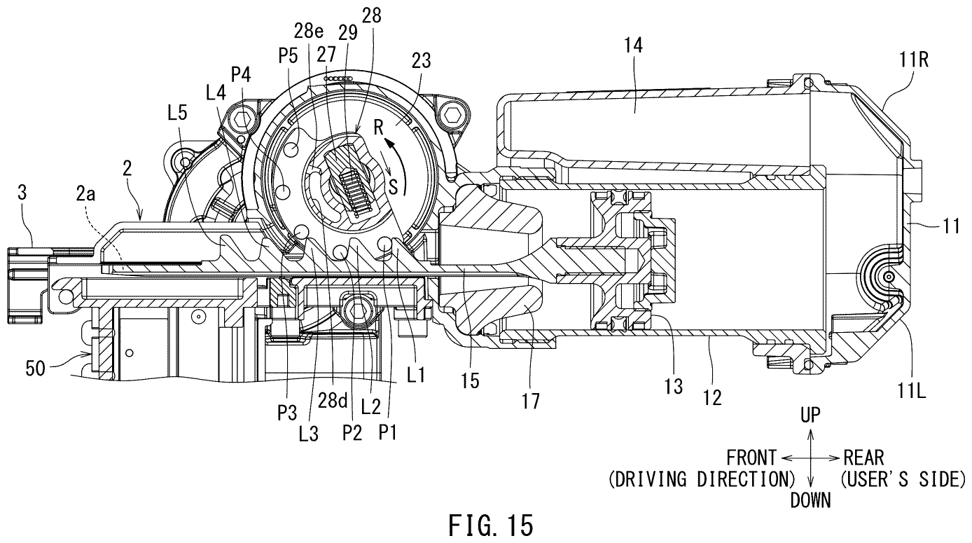

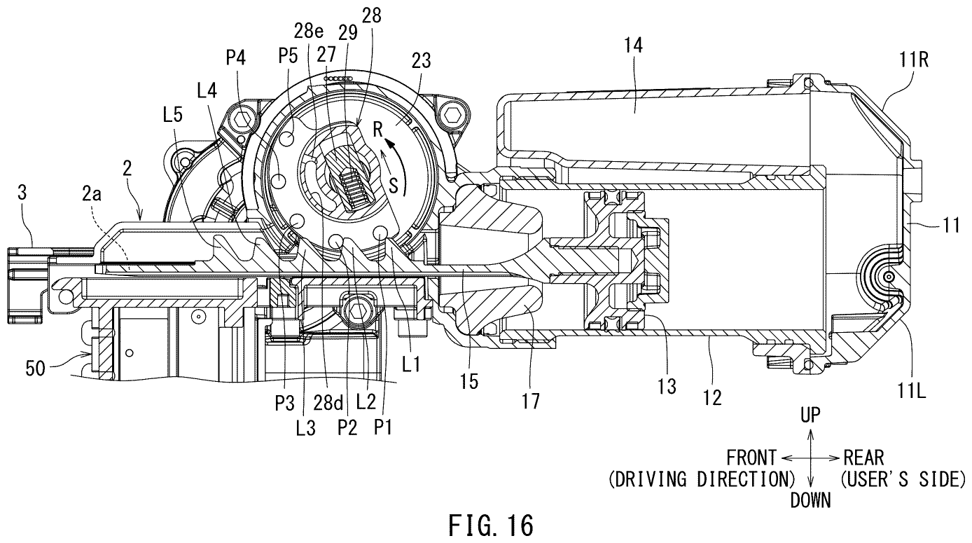

As shown in FIG. 15, after the returning movement begins, the wheel 28 rotates further in the R direction, and the first engaging portion P1 meshes with the first rack tooth L1. Then, the second engaging portion P2 meshes with the second rack tooth L2. At this time, the thrust of the gas pressure acting on the wheel 28 increases. For this reason, as shown in FIG. 16, the wheel 28 is displaced to the retracted position against the biasing member 29. As a result, the engagement of the first engaging portion P1 with the first rack tooth L1 and the engagement of the second engaging portion P2 with the second rack tooth L2 both become shallow.

When the wheel 28 rotates further in the R direction and the last engaging portion P5 meshes with the front surface of the last rack tooth L5, the driver is returned to the standby position shown in FIG. 10. The wheel 28 rotates in the R direction while remaining displaced to the retracted position. In the standby position shown in FIG. 10, gas pressure acts in a direction to push the wheel 28 downward to the retracted position against the biasing member 29 with respect to the last engaging portion P5.

In this way, in normal driving operation, the wheel 28 is displaced from the reference position to the retracted position during the returning movement of the driver 15. Then, at the retraction end position, the last engaging portion P5 moves away from the last rack tooth L5. At this stage (driving start stage), the wheel 28 is returned from the retracted position to the reference position. In normal driving operation, the displacement of the wheel 28 from the reference position to the retracted position is caused by the thrust of the gas pressure applied through normal meshing between the engaging portion P of the wheel 28 and the rack tooth L of the driver 15. On the other hand, in abnormal driving operations such as nail jamming, the displacement of the wheel 28 from the reference position to the retracted position is caused by a reaction accompanying abnormal meshing (interference) between the engaging portion P of the wheel 28 and the rack tooth L of the driver 15.

According to the above-described embodiment, the lift mechanism 20 biases the wheel 28 in the direction away from the driver 15 (toward the reference position) with respect to the lifter shaft 27 so that the last engaging portion P5 moves away from the last rack tooth L5 at the retraction end position of the driver 15. Then, when the driver 15 is moved from the leading end position to the standby position against the gas pressure, the biasing member 29 is elastically deformed as the wheel 28 is displaced in the direction away from the driver 15 with respect to the lifter shaft 27 (toward the retracted position).

Therefore, at the retraction end position of the driver 15, the last engaging portion P5 smoothly disengages from the last rack tooth L5, which more reliably reduces wear on the last rack tooth L5. The wheel 28 can rotate around the lifter shaft 27 and move toward and away from the driver 15. The wheel 28 is biased relative to the lifter shaft 27 by the biasing member 29. The biasing member 29 elastically deforms as the wheel 28 moves away from the driver 15 relative to the lifter shaft 27. When the driver 15 strikes the driven member n and is forced back against the gas pressure, the biasing member 29 flexes. This mechanism helps prevent the wheel 28 from locking up, for example, during a nail jam, by allowing the meshing of the engaging portion P to shift out of alignment with the rack tooth L.

By the configuration for avoiding the meshed and locked state at the start of lifting, the last engaging portion P5 quickly slides away from the last rack tooth L5 immediately before the driving operation begins, as the wheel 28 is biased in the direction away from the driver 15 (toward the reference position) relative to the lifter shaft 27. This reduces wear of the last rack tooth L5.

According to the embodiment, the lifter shaft 27 has a guide surface 27b of a width-across-flats portion 27a, and the wheel 28 slidably moves in the radial direction with respect to the lifter shaft 27 along the guide surface 27b. Therefore, the wheel 28 slidably moves in the radial direction with respect to the lifter shaft 27 via the guide surface 27b of the width-across-flats portion 27a.

According to the embodiment, a biasing member 29 is disposed between the guide surfaces 27b of the width-across-flats portion 27a. Thus, the biasing member 29 is compactly disposed on the lifter shaft 27.

According to the embodiment, the last engaging portion P5 is located forward of the rotation direction R of the wheel 28 with respect to a virtual plane K including the guide surface 27b of the width-across-flats portion 27a. Therefore, the wheel 28 is easily slidable in the radial direction immediately before the last engaging portion P5 disengages from the last rack tooth L5.

According to the embodiment, the plurality of engaging portions P include a first engaging portion P1 that first engages with a plurality of rack teeth L when the driver 15 is moved against gas pressure. At least a part of the first engaging portion P1 is located between two virtual planes K including guide surfaces 27b of the width-across-flats portion 27a. Therefore, the wheel 28 is easily slidable in the radial direction at the stage when the first engaging portion P1 is engaged with the rack tooth L of the driver 15.

According to the embodiment, the last rack tooth L5 has a flat surface 15b and a circular arc surface 15c which sequentially come into contact with the engaging portion P and have different extending directions. Therefore, as the engaging portion P moves from the flat surface 15b of the last rack tooth L5 to the circular arc surface 15c, the external force applied to the engaging portion P from the last rack tooth L5 changes. As a result, immediately before the driving operation, the wheel 28 slides in the direction away from the driver 15 (toward the reference position) due to the biasing force of the biasing member 29, thereby reducing wear of the last rack tooth L5.

According to the embodiment, the engaging surface 15a of the last rack tooth L5 includes a flat surface 15b and a circular arc surface 15c. When the last engaging portion P5 moves from the flat surface 15b to the circular arc surface 15c, the wheel 28 moves due to the biasing force of the biasing member 29. Therefore, as the direction of the external force applied from the last rack tooth L5 changes when the last engaging portion P5 moves from the flat surface 15b to the circular arc surface 15c, the wheel 28 smoothly moves in the direction away from the driver 15 (toward the reference position) due to the biasing force of the biasing member 29.

According to the embodiment, the wheel 28 has a grease sump 28d between the plurality of engaging portions P and the lifter shaft 27. Grease is fed from the grease sump 28d to at least one of the plurality of engaging portions P. Therefore, grease flows due to centrifugal force generated by rotation of the wheel 28 and is fed to at least one of the plurality of engaging portions P.

According to the embodiment, the grease sump 28d extends in a circular arc shape. A grease filling hole 28e extends from a rear end of the grease sump 28d in a rotation direction R of the wheel 28 toward the last engaging portion P5. Therefore, grease is efficiently fed to the last engaging portion P5 through the grease filling hole 28e.

According to the embodiment, the last rack tooth L5 includes a flat surface 15b and a circular arc surface 15c with different extending directions. When the last engaging portion P5 moves from the flat surface 15b to the circular arc surface 15c and the last engaging portion P5 leaves the circular arc surface 15c, the guide surface 27b of the lifter shaft 27 is located substantially parallel to the flat surface 15b of the last rack tooth L5. Therefore, the wheel moves rapidly in the direction away from the driver 15 due to the biasing force of the biasing member 29, thereby reducing wear of the last rack tooth L5.

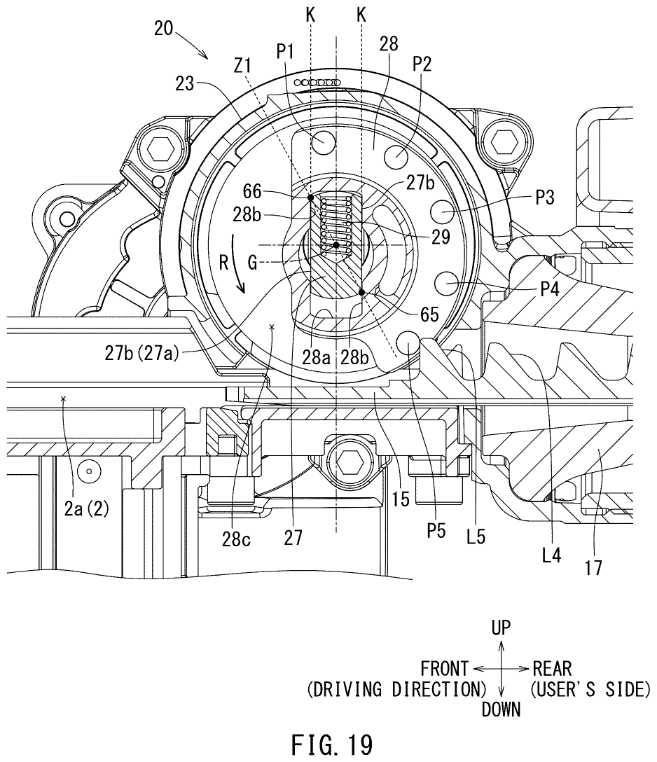

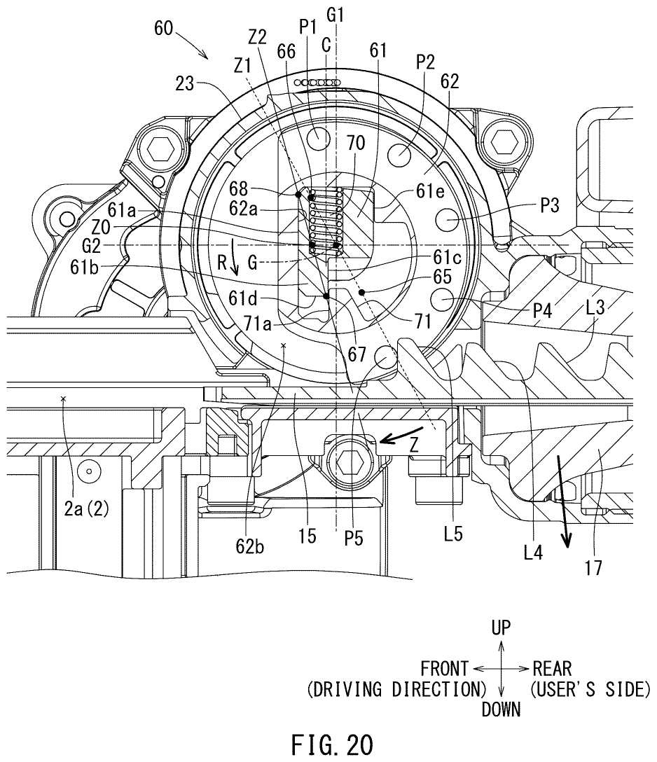

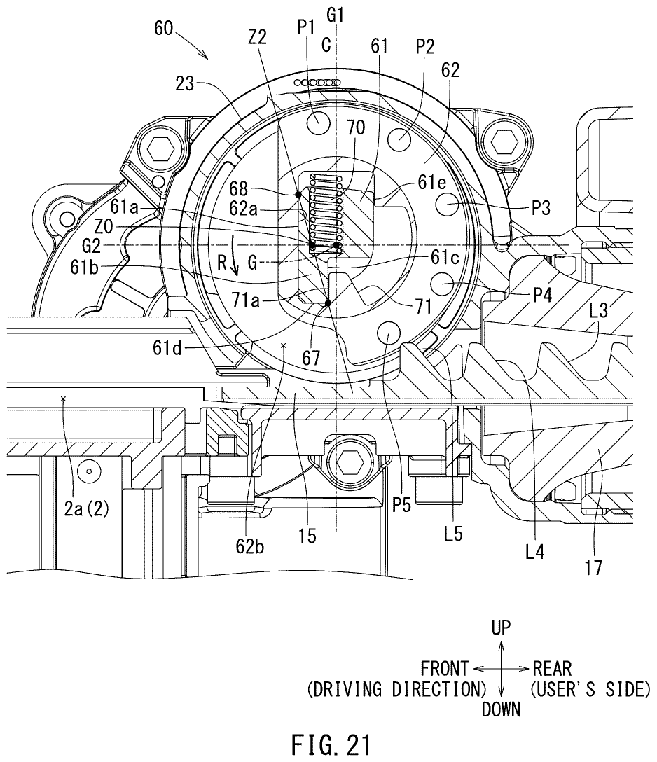

Various modifications may be made to the above-described embodiments. FIGS. 20 and 21 show a lift mechanism 60 according to a second embodiment. The lift mechanism 60 has been modified with respect to the lifter shaft 61 and the wheel 62. FIG. 19 is a partially enlarged view of FIG. 11, showing an enlarged view of the lift mechanism 20 of the first embodiment.

As shown in FIG. 19, in the first embodiment, the wheel 28 is supported on the width-across-flats portion 27a of the lifter shaft 27. The two guide surfaces 27b of the width-across-flats portion 27a extend in a direction orthogonal to the axis of rotation G of the lifter shaft 27. The support surfaces 28b on the wheel 28 side are slidably abutted to the two guide surfaces 27b, respectively. Therefore, force points 65 and 66 are provided where each of the two guide surfaces 27b contacts the wheel 28 when the lifter shaft 27 transmits the rotational power in the direction of the arrow R to the wheel 28.

The two guide surfaces 27b are arranged in a line-symmetrical relationship with respect to the center line passing through the axis of rotation G (center of rotation of the lifter shaft 27). The two force points 65 and 66 are located in a point-symmetrical relationship about the axis of rotation G. The force point 65 is located at the lower part of the guide surface 27b on the side close to the last engaging portion P5, and the force point 66 is located at the upper part of the guide surface 27b on the side away from the last engaging portion P5. Thus, in the first embodiment, a line of force Z1 connecting the two force points 65 and 66 passes through the axis of rotation G.

In the first embodiment, the last engaging portion P5 is located on the front side of the rotation direction with respect to the line of force Z1. As a result, an external force acts to displace the wheel 28 to the retracted position with respect to the last engaging portion P5.

As shown in FIG. 20, the lift mechanism 60 according to the second embodiment has a modified lifter shaft 61. Components and configurations that do not require modification from the first embodiment will not be described again by using the same reference numerals. In the second embodiment, the lifter shaft 61 is formed with an increased width on both the front and rear sides about a virtual axis G1, which passes through the axis of rotation G and is orthogonal to the moving direction of the driver 15. The axis of rotation G of the lifter shaft 61 passes through an intersection of a virtual axis G2 parallel to the moving direction of the driver 15 and the virtual axis G1 orthogonal to the moving direction of the driver 15.

The lifter shaft 61 has a reduced width on the end (the side close to the last engaging portion P5) closer to the last engaging portion P5, creating a protruding portion 61b on one side end of the lifter shaft 61 that extends parallel to a virtual axis G1. One guide surface 61c is provided on the rear side (the side opposite to the engaging portion P) of the protruding portion 61b. The other guide surface 61a is provided on the front side (the side away from the engaging portion P) of the lifter shaft 61, including the protruding portion 61b. The guide surface 61a and the guide surface 61c are arranged in parallel to each other. These guide surface 61a and the guide surface 61c together form a width-across-flats portion 61d.

The other guide surface 61a is slidably in contact with a support hole 62a of the wheel 62. Therefore, a force point 68 is provided at the upper part of the other guide surface 61a.

A guide receiving surface 71a of an acting part 71 is in contact with the guide surface 61c on the side close to the engaging portion P. The acting part 71 is integrally formed with the support hole 62a of the wheel 62. The acting part 71 is provided so as to protrude toward the axis of rotation G. The guide receiving surface 71a is provided on the front side of the acting part 71. The guide surface 61c of the lifter shaft 61 is slidably in contact with the guide receiving surface 71a. Thus, a force point 67 is provided at the lower part of the guide surface 61c.

In the second embodiment, the guide surface 61c on the engaging portion P side is displaced toward a side away from the engaging portion P with respect to the virtual axis G1. Therefore, the guide surface 61c in the second embodiment is farther away from the engaging portion P than the guide surface 27b in the first embodiment. As a result, the force point 67 on the engaging portion P side is displaced toward the side away from the engaging portion P with respect to the virtual axis G1.

In the second embodiment, the lifter shaft 61 is formed to be wide, so that the guide surface 61a on the side away from the engaging portion P is displaced to a position farther away from the engaging portion P. As a result, the force point 68 is displaced to a position farther away from the engaging portion P than the force point 66 in the first embodiment. In FIG. 20, the force points 65 and 66 and the line of forces Z1 of the first example are shown for comparison with the force points 67 and 68 and the line of forces Z2 of the second example.

The center point Z0, which lies on the line of force Z2 connecting the two force points 67 and 68 and is centered in the sliding direction (extending direction of the guide surfaces 61a and 61c) of the force points 67 and 68, is displaced in the direction away from the engaging portion P with respect to the axis of rotation G. The center point Z0 is located on the virtual axis G2. Therefore, the line of force Z2 of the second embodiment is displaced in the direction away from the engaging portion P with respect to the line of force Z1 of the first embodiment. In the second embodiment, the line of force Z2 is displaced to the rear side of the rotation direction R of the wheel 62, as indicated by the arrow Z. This allows the last engaging portion P5 to be positioned further rearward in the rotation direction R.

In the first embodiment shown in FIG. 19, the last engaging portion P5 is located on the front side of the rotation direction R of the wheel 28 with respect to the line of force Z1. On the other hand, in the second embodiment shown in FIG. 20, the last engaging portion P5 is displaced to the rear side of the rotation direction R with respect to the line of force Z1 of the first embodiment. Allowing the installation range of the last engaging portion P5 to expand rearward in the rotation direction R makes it possible to reduce the diameter of the wheel 62 by arranging each engaging portion P more inwardly with respect to the axis of rotation G of the lifter shaft 61 while ensuring the circumferential length of the engaging portion P in the installation range (the lift amount of the driver 15). By reducing the diameter of the wheel 62, the axis of rotation G of the lifter shaft 61 may be disposed closer to the driver 15. This allows the lift base 23 (inner housing) that accommodates the wheel 62 to be made smaller in diameter.

A lateral side of the lifter shaft 61 on the side of the engaging portion P, which is formed wider than the lifter shaft 27 in the first embodiment, is determined as an auxiliary side surface 61e. The auxiliary side surface 61e is slidably fitted to the support hole 62a of the wheel 62.

As in the first embodiment, a coil spring (compression spring) is used as the biasing member 70. Unlike the first embodiment, in the second embodiment, the biasing member 70 is offset on the side away from the engaging portion P with respect to the virtual axis G1. Therefore, the biasing member 70 is displaced from an intermediate position between the guide surface 61a and the auxiliary side surface 61e of the lifter shaft 61 toward the guide surface 61a. A center line C of the biasing member 70, which extends in the biasing direction through the center of the biasing member 70, is substantially aligned with the guide surface 61c. Therefore, the biasing member 70 is located on the side away from the last engaging portion P5 with respect to the axis of rotation G of the lifter shaft 61.

As in the first embodiment, the wheel 62 is biased toward the reference position with respect to the lifter shaft 61 by the biasing member 70. The guide surface 61c is located within the width area (radially inner side) of the biasing member 70, and the guide surface 61a is located outside the width area (radially outside) of the biasing member 70. The guide receiving surface 71a of the acting part 71 of the wheel 62 is in relatively slidable contact with the guide surface 61c located within the width area of the biasing member 70.

According to the lift mechanism 60 of the second embodiment, as the wheel 62 rotates in the direction of the arrow R, the last engaging portion P5 meshes with the front side of the last rack tooth L5, causing the driver 15 to return to its standby position (shown in FIG. 20). The rotational movement of the lifter shaft 61 is transmitted to the wheel 62 through force points 67 and 68. During the return of the driver 15, the wheel 62 moves from its reference position to the retracted position. The wheel 62 continues to rotate in the direction of the arrow R while remaining in the retracted position. At the standby position (shown in FIG. 20), gas pressure pushes the wheel 62 downward to the retracted position, counteracting the biasing member 70 at the last engaging portion P5.

When the wheel 62 rotates in the direction of the arrow R and reaches the retracted end position from the standby position, the last engaging portion P5 comes slidably in contact with the engaging surface 15a (flat surface 15b and circular arc surface 15c) of the last rack tooth L5, as in the first example. When the last engaging portion P5 passes through the flat surface 15b and leaves the circular arc surface 15c, the wheel 62 is instantaneously displaced in the direction away from the driver 15 with respect to the lifter shaft 61 (reference position) by the biasing force of the biasing member 70, as shown in FIG. 21, because the thrust of the driver 15 ceases to act. As a result, the last engaging portion P5 quickly moves away from the last rack tooth L5. The wear of the last rack tooth L5 is reduced as the last engaging portion P5 quickly moves away from the last rack tooth L5.

When the last engaging portion P5 moves away from the last rack tooth L5, the relief section 62b faces the driver 15, allowing the driver 15 to move forward due to the gas pressure acting on the rear side of the piston 13, thereby initiating the driving operation. The wheel 28 continues to rotate in the direction of the arrow R while being returned to the reference position. When the driver 15 reaches the downward movement end, the first engaging portion P1 engages with the front side of the first rack tooth L1, and the driver 15 is lifted toward the standby position. As in the first embodiment, when a nail jam or the like occurs, the first engaging portion P1 is displaced from the reference position to the retracted position by an external force acting on the first engaging portion P1 against the biasing member 70, thereby avoiding abnormal meshing of the first engaging portion P1.

In the second embodiment, the lifter shaft 61 has two guide surfaces 61a and 61c that extend in a direction orthogonal to the axis of rotation G of the lifter shaft 61 and slidably hold the wheel 62 in the extending direction. The lifter shaft 61 has two guide surfaces 61a and 61c, each of which has a force point 68 and 67 that contacts the wheel 62 when the lifter shaft 61 transmits rotational power to the wheel 62. The line of force Z2 connecting the two force points 68 and 67 is located further away from the axis of rotation G on the opposite side of the engaging portion P provided on the wheel 62. As a result, the center point Z0 of the two force points 68 and 67 in the sliding direction is located on the opposite side of the engaging portion P with respect to the axis of rotation G. Therefore, even when the last engaging portion P5 is disposed further rearward in the rotation direction R, the wheel 62 can be displaced in the direction away from the driver 15 by the biasing force of the biasing member 70 when the last engaging portion P5 leaves the last rack tooth L5.

As a result, the wheel 62 slides toward the retracted position both at the point when the first engaging portion P1 engages with the first rack tooth L1 at the start of the lift and at the point when the last engaging portion P5 disengages from the last rack tooth L5 at the end of the lift. This configuration makes it possible to reduce the wheel diameter while ensuring the lift amount of the driver 15. By reducing the wheel diameter, the lifter shaft 61 and the wheel 62 can be placed closer to the driver 15 side. Consequently, the inner housing that houses the wheel 62 may be made smaller, which in turn reduces the size of the driving tool 1.

According to the second embodiment, among the two guide surfaces 61a and 61c, the guide surface 61c that is closer to the last engaging portion P5 is closer to the virtual line G1 that passes through the axis of rotation G and extends in the extending direction of the guide surfaces 61a and 61c than the other guide surface 61a. Therefore, even if the last engaging portion P5 is disposed further rearward in the rotation direction R, the wheel 62 can be separated from the driver 15 by the biasing force of the biasing member 70.

In the second example, the center line C of the biasing member, which extends in the biasing direction through the center of the biasing member 70, is positioned farther away from the last engaging portion P5 with respect to the axis of rotation G of the lifter shaft 61. Therefore, the biasing member 70 is offset to the rear side of the rotation direction R with respect to the axis of rotation G of the lifter shaft 61. As a result, the lifter shaft 61 displaces the force point 67 on the side of the last engaging portion P5 of the two force points 68 and 67 to the side away from the last engaging portion P5. The wheel 62 is then displaced smoothly in the radial direction with respect to the lifter shaft 61.

In the second embodiment, the biasing member 70 is a coil spring. The guide surface 61c on the front side of the rotation direction R is located within the width area of the coil spring (biasing member 70). The guide surface 61a on the rear side of the rotation direction R is located outside the width area. Therefore, the biasing member 70 is compactly arranged over the area between the guide surfaces 61a and 61c.

In the second embodiment, the guide surface 61c is located within the width area of the coil spring. An acting part 71 having a guide receiving surface 71a slidably in contact with the guide surface 61c is provided on the wheel 62. Therefore, a force point 67 on the side of the last engaging portion P5 is set between the guide surface 61c and the guide receiving surface 71a.

Modification can be made to the second embodiment. In the first embodiment, the line of force Z1 goes through the rotation axis of rotation G of the lifter shaft 27. However, in the second embodiment, the force point 67 (located on the front side of the rotation direction R) is shifted to further rear side of the rotation direction R than that of the first embodiment. This causes the line of force Z2 to be displaced further to the rear side of the rotation direction R than the line of force Z1 that was in the first embodiment. Specifically, the line of force Z2 is moved to the opposite side of the engaging portion P of the wheel 62 relative to the axis of rotation G. Therefore, the force point 67 on the front side of the rotation direction R in the second embodiment is set further to the rear side of the rotation direction R than the force point 65 in the first embodiment. This configuration allows the last engaging portion P5 to move further to the rear side of the rotation direction R. For example, the force point 67 may be set on the virtual axis G1. Alternatively, the force point 67 may be set further on the front side of the rotation direction R relative to the virtual axis G1. Both options allow for a more compact lift mechanism 60 by reducing the side of the wheel 62 while keeping the same lifting distance as the driver.

The first and second examples described above may be further modified. For example, the wheels 28 and 62 having five engaging portions P and a driver 15 having five rack teeth L have been described as examples. Instead, the number of engaging portions P and rack teeth L may be reduced or increased. Even in such cases, as described as examples, the wheels 28 and 62 may be configured to be returned to their reference positions (displaced away from the driver 15) at the retracted end position of the driver 15.

The lift mechanisms 20 and 60 have been described as examples in which the axis of rotation G of the wheels 28, 62 (lifter shafts 27, 61) is orthogonal to the motor axis J. Alternatively, the support structure of the wheels 28, 62 described as examples may be applied to the lift mechanism in which the wheels are arranged coaxially on the motor axis J.

A gas-spring powered driving tool that uses the thrust of compressed gas as the driving force has been described as an example. Alternatively, the support structure of the wheel 28 described as an example may also be applied to a mechanical spring type driving tool that uses thrust of a compression spring as the driving force.

What is claimed is:

1. A driving tool comprising:
a driver configured to strike a driven member using gas pressure;
a plurality of rack teeth on the driver arranged along a driving direction;
a wheel having a plurality of engaging portions that sequentially engages the plurality of rack teeth when the wheel rotates;
a lifter shaft configured to support the wheel, wherein the lift shaft is rotatable and displaceable in a direction toward and away from the driver; and
a biasing member,
wherein the biasing member is configured to allow the wheel to displace relative to the lifter shaft in a direction away from the driver for enabling a last engaging portion of the plurality of engaging portions to disengage from a last rack tooth of the plurality of rack teeth, wherein the last rack tooth is located at an outermost end in the driving direction, and wherein the biasing member elastically deforms when the wheel is displaced in the direction away from the driver relative to the lifter shaft, and when the driver strikes the driven member and moves against the gas pressure.

2. The driving tool according to claim 1, further comprising guide surfaces of a width-across-flats portion provided on the lifter shaft, wherein the wheel is slidably movable in a radial direction with respect to the lifter shaft along the guide surface.

3. The driving tool according to claim 2, wherein the biasing member is disposed between the guide surfaces of the width-across-flats portion.

4. The driving tool according to claim 2, wherein the last engaging portion is located forward of a rotation direction of the wheel with respect to virtual planes including each of the guide surfaces of the width-across-flats portion.

5. The driving tool according to claim 2, wherein the plurality of engaging portions includes a first engaging portion that first engages with the plurality of rack teeth when the driver is moved against gas pressure, and at least a part of the first engaging portion is located between two virtual planes including each of the guide surfaces of the width-across-flats portion.

6. The driving tool according to claim 1, wherein the last rack tooth has a plurality of engaging surfaces having different extending directions wherein the plurality of engaging surfaces sequentially contacts the last engaging portion, and
wherein after the last engaging portion moves from an initial engaging surface of the plurality of engaging surfaces to an engaging surface of the plurality of engaging surfaces different from the initial engaging surface, the wheel is displaced in a direction away from the driver due to a biasing force of the biasing member.

7. The driving tool according to claim 6, wherein the plurality of engaging surfaces of the last rack tooth includes a flat surface and a circular arc surface, and wherein after the last engaging portion moves from the flat surface to the circular arc surface, the wheel is displaced due to the biasing force of the biasing member.

8. The driving tool according to claim 1, wherein the wheel has a grease sump between the plurality of engaging portions and the lifter shaft, and wherein grease is fed from the grease sump to at least one of the plurality of engaging portions.

9. The driving tool according to claim 8, wherein the grease sump extends in a circular arc shape, and wherein a grease filling hole extends from a rear end of the grease sump in a rotation direction of the wheel toward the last engaging portion.

10. The driving tool according to claim 2, wherein the last rack tooth includes a flat surface and a circular arc surface with different extending directions each other, and
wherein the guide surface of the lifter shaft is located substantially parallel to the flat surface of the last rack tooth, when the last engaging portion moves from the flat surface to the circular arc surface and the last engaging portion leaves the circular arc surface.

11. The driving tool according to claim 1, wherein the lifter shaft has two guide surfaces that extend in a direction orthogonal to an axis of rotation of the lifter shaft and slidably hold the wheel, wherein the lifter shaft has at least two force points where each of the two guide surfaces contacts the wheel when the lifter shaft transmits the rotational power to the wheel, and
wherein a center of the at least two force points is located on the opposite side of the engaging portions provided on the wheel with respect to the axis of rotation.

12. The driving tool according to claim 11, wherein one of the two guide surfaces being nearest to the last engaging portion is located closer to a center line that passes through the axis of rotation and extends in the extending direction of the guide surface than the other guide surface.

13. The driving tool according to claim 12, wherein the biasing member has a centerline that extends in a biasing direction through the center of the biasing member and is located on the opposite side to the engaging portion with respect to the axis of rotation of the lifter shaft.

14. The driving tool according to claim 11, wherein the biasing member is a coil spring,
wherein one of the two guide surfaces are located within a width area of the coil spring, and
wherein the other is located outside the width area.

15. The driving tool according to claim 14 further has an acting part that includes a guide receiving surface, wherein the guide receiving surface slidably contacts the guide surface located within the width area of the coil spring and is located on the wheel.

16. A driving tool comprising:
a driver configured to strike a driven member using gas pressure;
a plurality of rack teeth on the driver arranged along a driving direction;
a wheel having a plurality of engaging portions that sequentially engage with the plurality of rack teeth as the wheel rotates;
a lifter shaft configured to support the wheel, wherein the lift shaft is rotatable and displaceable in a direction toward and away from the driver;
a guide surface configured to allow the wheel to slide radially, wherein the guide surface is a width-across-flats portion located on the lifter shaft; and
a biasing member, wherein the biasing member is configured to allow the wheel to displace relative to the lifter shaft in a direction away from the driver for enabling the last engaging portion to disengage from the last rack tooth, wherein the last rack tooth is located at an outermost end in the driving direction, and wherein the biasing member elastically deforms as the wheel is displaced in the direction away from the driver relative to the lifter shaft, and when the driver strikes the driven member and moves against the gas pressure.

17. The driving tool of claim 16, wherein the guide surface comprises two parallel guide surfaces configured to form the width-cross-flats portion, wherein the two parallel guide surfaces are positioned on opposite sides of the width-cross-flats portion.

18. The driving tool of claim 17, wherein the guide surfaces extend in a direction orthogonal to an axis of rotation of the lifter shaft.

19. The driving tool of claim 16, wherein the wheel has a plurality of support surfaces configured that contact the two parallel guide surfaces for ensuring stable-sliding motion.
